(19) United States
(12) Patent Application Publication
(10) Pub. No.: US 2011/0260867 A1
(43) Pub. Date: Oct. 27, 2011

(54) CABLE LOCK WITH ALARM

(76) Inventors: Robert E. McCracken, Anderson, SC (US); Ryan T. Harrison, Anderson, SC (US); Christopher Clearman, Anderson, SC (US)

(21) Appl. No.: 12/764,237

(22) Filed: Apr. 21, 2010

(51) Int. Cl. G08B 13/12; E05B 67/02; E05B 47/00; E05B 67/06

(52) U.S. Cl. 340/568.4; 70/53; 70/52; 70/275

(57) ABSTRACT

A lock for engaging a cable. The lock has a housing with an aperture through which the cable may pass. A first locking member and second locking member are coupled to the housing. A first biasing member is configured to bias the first locking member towards the cable to prevent cable movement in a first direction. A second biasing member is configured to bias the second locking member away from the cable. A third biasing member is configured to selectively bias the second locking member towards the cable to prevent cable movement in a second direction. A trigger is movably coupled to the housing, with the trigger configured to selectively deflect the first locking member away from the cable.

### BACKGROUND

The present invention relates to portable locking devices. More specifically, the invention relates to a cable lock with a variable length cable loop.

Cable locks are used to secure portable objects such as bicycles or motorcycles by passing a length of cable through a frame or wheel, for example. Existing cable locking devices have a cable loop with a fixed length.

### SUMMARY

In one embodiment, the invention provides a lock for engaging a cable. The lock has a housing with an aperture through which the cable may pass. A first locking member and a second locking member are coupled to the housing. A first biasing member is configured to bias the first locking member towards the cable to prevent cable movement in a first direction. A second biasing member is configured to bias the second locking member away from the cable. A third biasing member is configured to selectively bias the second locking member towards the cable to prevent cable movement in a second direction. A trigger is movably coupled to the housing, with the trigger configured to selectively deflect the first locking member away from the cable.

In another embodiment, the invention provides a cable lock. The cable lock includes a housing having a first aperture and a cable having a first end and a second end. The first end is coupled to the housing and the second end selectively passes through the first aperture. A first cam member is pivotally coupled to the housing. The first cam member is biased to impinge upon the cable to prevent cable movement in a first direction and selectively disengaged from the cable to allow cable movement in the first direction. A second cam member is pivotally coupled to the housing. The second cam member is biased away from the cable in a first condition and biased towards the cable in a second condition. The second condition prevents cable movement in a second direction.

Other aspects of the invention will become apparent by consideration of the detailed description and accompanying drawings.

### BRIEF DESCRIPTION OF THE DRAWINGS

FIG. 1 is a perspective view of a cable lock assembly according to one aspect of the invention.

FIG. 2A is a perspective view of the cable lock assembly of FIG. 1, illustrating a battery cover in a locked state.

FIG. 2B is a perspective view of the cable lock assembly of FIG. 1, with a battery cover in an unlocked state.

FIG. 2C is a perspective view of the cable lock assembly of FIG. 1, with a battery cover removed.

FIG. 3A is a cutaway view of the cable lock assembly of FIG. 1, in a locked state, with the battery cover and a portion of a housing removed.

FIG. 3B is a cutaway view of the cable lock assembly of FIG. 3A, in a cinch state.

FIG. 3C is a cutaway view of the cable lock assembly of FIG. 3A, in an unlocked state.

FIG. 4 is a schematic of a cable lock alarm circuit in an open circuit state, according to another aspect of the invention.

FIG. 5 is a schematic of the cable lock alarm circuit of FIG. 5 in a closed circuit state.

FIG. 6 is an alternative embodiment of a cable lock alarm circuit according to one aspect of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

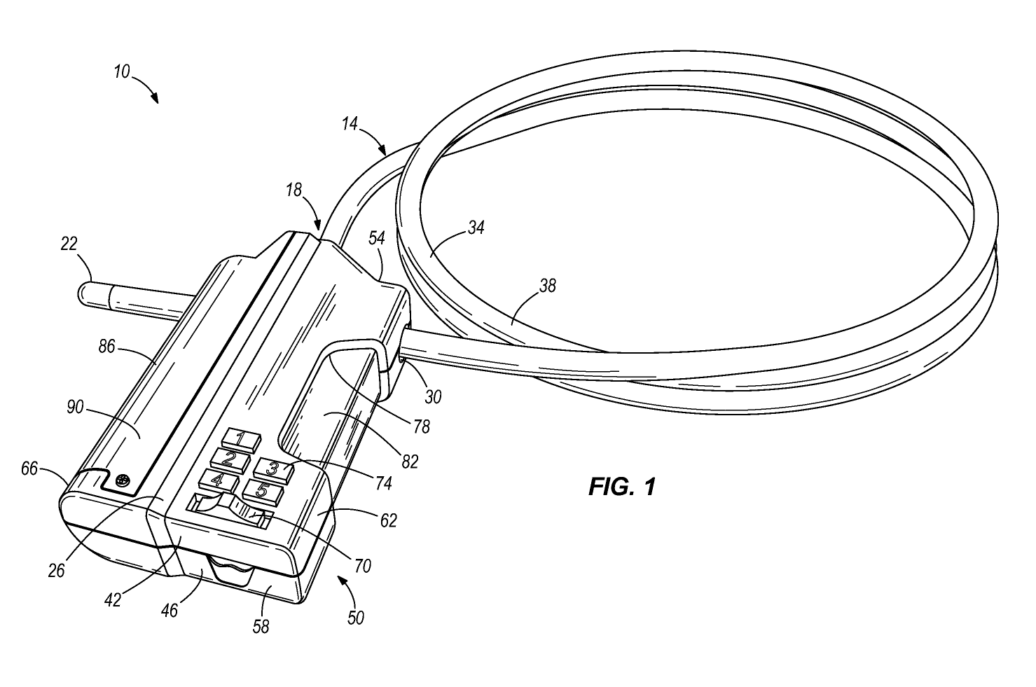

FIG. 1 illustrates a cable lock 10. The cable lock 10 has a cable 14 with a first end 18 and a second end 22. The first end 18 is pivotally coupled to a housing 26. The second end 22 passes through an aperture 30 of the housing 26 to form a loop 34, with the second end 22 hanging freely from the housing 26. The loop 34 may be varied in size depending on the position of the second end 22 relative to the housing 26. In other words, the cable lock is capable of engaging the cable 14 at any point between the first end 18 and the second end 22. In the illustrated embodiment, the cable 14 is a multi-strand, braided cable. The illustrated cable 14 has a resilient jacket layer 38. In other embodiments, the cable may be bare.

The housing 26 has a first half 42 and a second half 46. The first half 42 and second half 46 of the housing 26 define a cavity, or void, therebetween. The housing 26 is illustrated as having a rectangular profile 50 with a top end 54, a bottom end 58, a first edge 62, and a second edge 66. Other constructions may have various other shapes or forms. Furthermore, in other constructions the housing may be one-piece, or have more than two pieces.

The housing 26 has a switch 70 and a key pad 74 on one face. The switch 70 is used to activate the key pad 74. Alternatively, the switch 70 may be used to select a mode of the key pad 74, such as a lock mode and an unlock mode. In still other embodiments, the switch 70 may be removed, with all of the lock functions controlled by the key pad 74. The key pad 74 is used to enter a numerical (or alpha-numeric) sequence in order to unlock the lock 10. In other embodiments, key pads with more or fewer digits may be present. In still other embodiments, rotary dials, tumblers, or a key may used in place or in addition to the key pad 74.

A cutout 78 is formed along the first edge 62 of the housing 26. The cutout 78 provides access to a spring-biased trigger 82. As discussed in greater detail below, the trigger 82 provides a means of disengaging a locking mechanism from the cable 14, thereby allowing the cable 14 to be withdrawn from the housing 26.

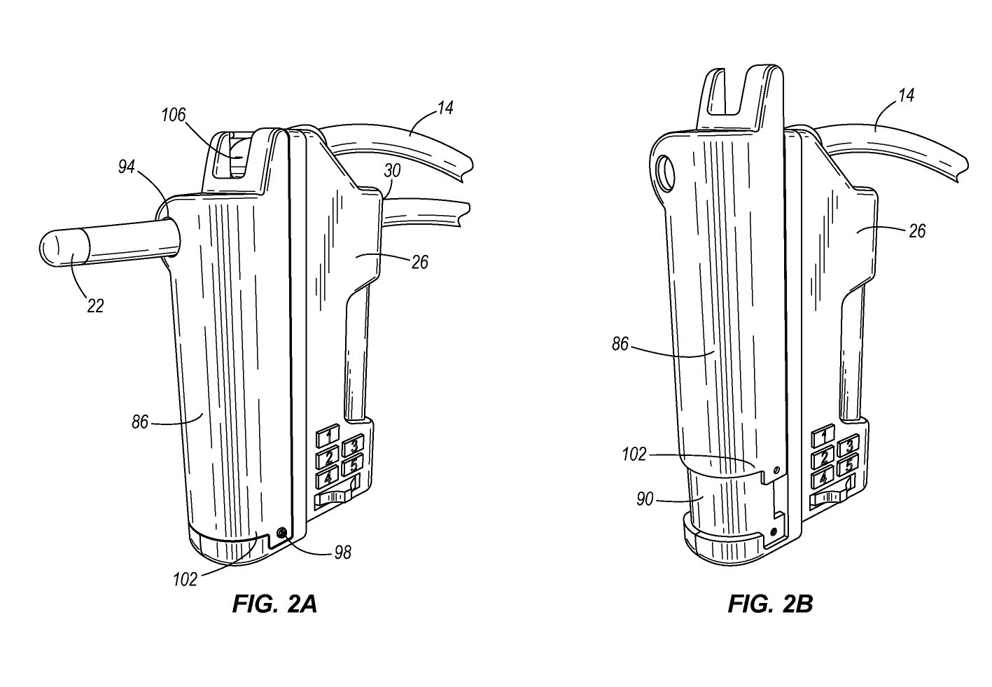

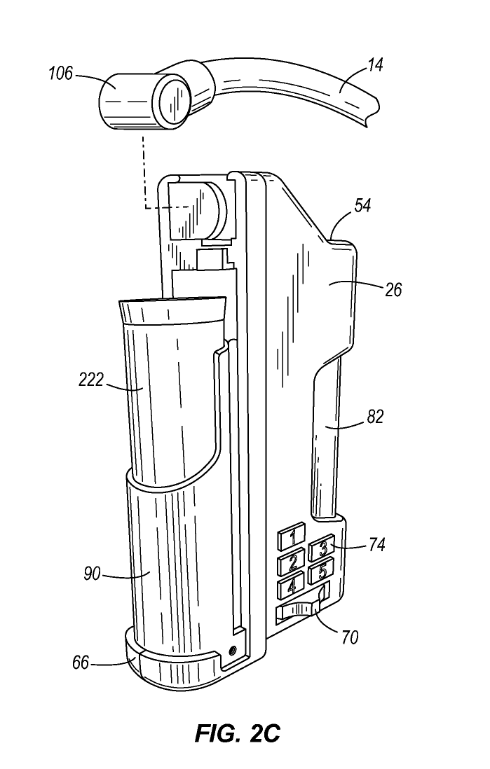

Along the second edge 66, opposite the first edge 62, a battery cover 86 is coupled to the housing 26. In the embodiment illustrated in FIGS. 2A-C, the battery cover 86 is slidably attached to the housing 26. The cover 86 encloses a battery compartment 90.

As shown in FIG. 2A, when the second end 22 of the cable 14 passes through the housing 26, the battery cover 86 is locked to the housing 26 by the cable 14. The cable 14 passes through a battery cover aperture 94. The battery cover aperture 94 is aligned with the housing aperture 30 when the battery cover 86 is installed on the housing 26. In the illustrated embodiment, a screw 98 is provided at a base portion 102 of the battery cover 86 for coupling the battery cover 86 to the housing 26. The screw 98 is provided as a secondary means of coupling the battery cover 86 and is not required in all embodiments. In other embodiments, a detent, spring clip, or other secondary coupling means may be provided. In still other embodiments, the battery cover 86 may be snap-fit to the housing 26.

As shown in FIG. 2B, in order to remove or exchange a battery from the battery compartment 90, the cable 14 must first be withdrawn from the housing 26 far enough to be disengaged from the battery cover aperture 94. Where a screw 98 or other fastener is provided, as in FIG. 2A, it is first removed. The battery cover 86 can then be slidingly disengaged from the housing 26.

As shown in FIG. 2C, once the battery cover 86 has been slidingly disengaged from the housing 26, the battery compartment 90 is accessible. As also illustrated in FIG. 2C, when the battery cover 86 is removed from the housing 26, the first end 18 of the cable 14 may be detached from the housing 26. This feature allows for replacement of the cable. A cylindrical end member 106 at the first end 18 of the cable 14 is normally captured within a pivot cavity 114 of the housing 26. The cylindrical end member 106 is crimped, welded, adhesively bonded or otherwise fastened to the first end 18 of the cable 14.

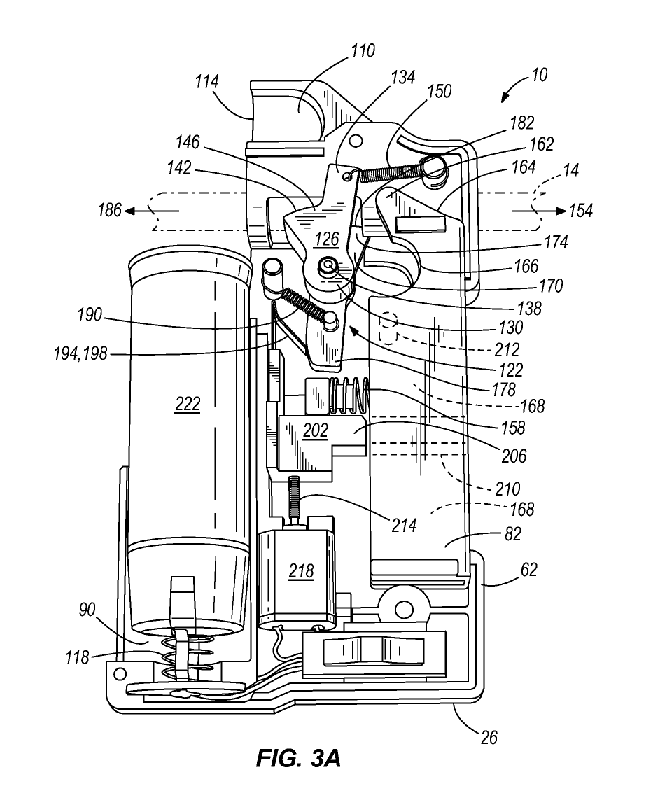

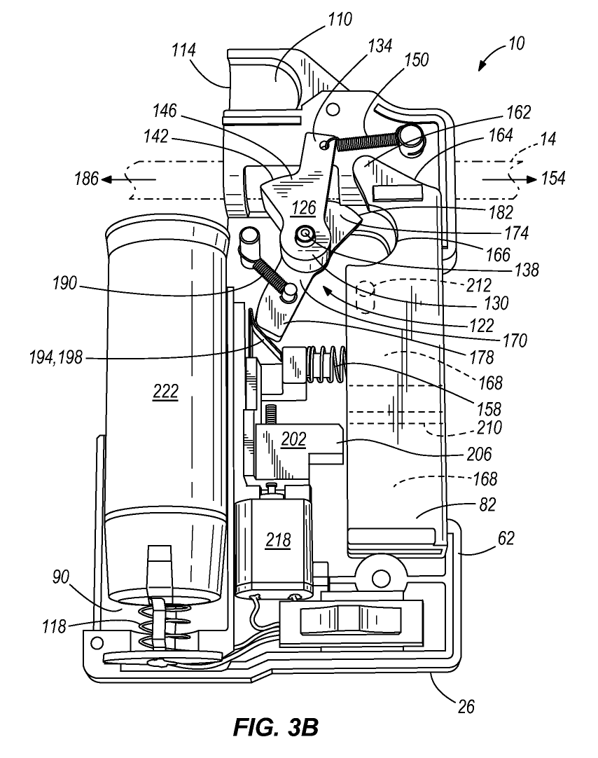

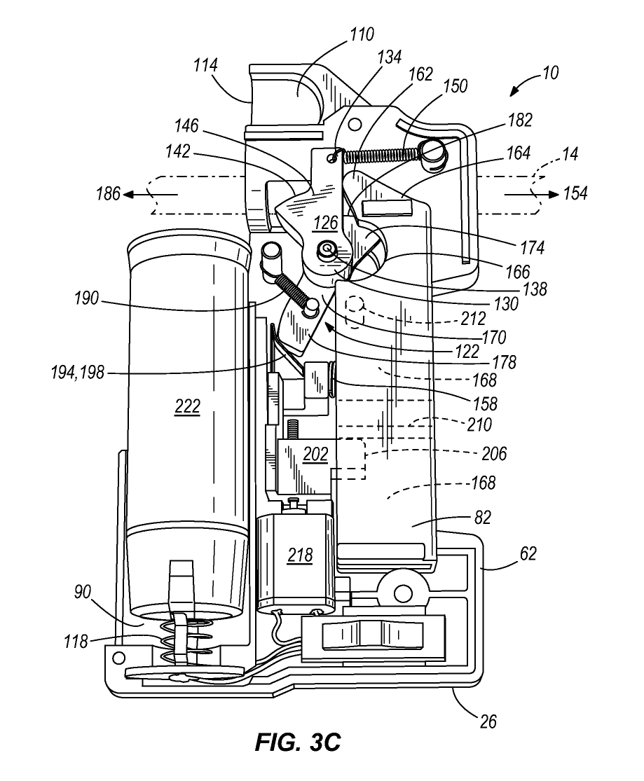

One half of the pivot cavity 110, as defined by the second half 46 of the housing 26, is illustrated in FIGS. 3A, B, and C. The pivot cavity 110 is configured to allow the first end 18 of the cable 14 to pivot with respect to the housing 26. The pivot cavity 110 is open at a battery compartment end 114 to allow the cylindrical end member 106 to be withdrawn from the pivot cavity 110. As also illustrated in FIGS. 3A, B, and C, the battery compartment 90 has a resilient contact 118 for a battery terminal.

FIGS. 3A, B and C are cutaway illustrations of the internal mechanism 122 of the cable lock 10. A first locking member 126 has a first end 130 and a second end 134. The first locking member 126 is pivotally coupled at the first end 130 via a pivot pin 138. Intermediate the first end 130 and the second end 134, a first locking surface 142 is provided. In the illustrated embodiment, the first locking surface 142 is formed by a cam 146 configured to engage and compress the resilient jacket 38 of the cable 14. In some embodiments, the locking surface 142 may have a knurling or other texturing to prevent cable slippage. A first resilient member 150 is coupled to the second end 134 of the first locking member 126 and the housing 26. In the illustrated embodiment, the first resilient member 150 is a first coil extension spring. The first resilient member 150 biases the first locking member 126 towards the cable 14 (i.e., the clockwise direction, when viewed from the orientation of FIG. 3A), thereby preventing further cable movement in a first direction 154.

The trigger 82, a portion of which was illustrated and described in FIG. 1 is shown in greater detail in FIGS. 3A, B and C. The trigger 82 is configured to slide within the housing 26. In other embodiments, the trigger 82 may be pivotally coupled to the housing 26 rather than slidably coupled. The trigger 82 is biased towards the first edge 62 of the housing 26 by a coil compression spring 158. When a user applies force to push the trigger into the housing, the biasing force of the spring 158 is overcome. A nub 162 is provided on a first end 164 the trigger 82. The nub 162 is provided to disengage the first locking member 126 from the cable 14 by overriding the biasing force of the first resilient member 150. The nub 162 rotates the first locking member 126 away from the cable 14 (i.e., in the counterclockwise direction as illustrated). A clearance notch 166 is provided in the trigger 82 to allow the nub 162 to fully disengage the first locking member 126 from the cable 14, without the trigger 82 contacting the first end 130 of the locking member 126. As explained in greater detail below, the trigger 82 has hollow portions 168 to allow the trigger 82 to slide over other mechanical components of the internal mechanism 122.

A second locking member 170 is also pivotally coupled to the housing 26. In the illustrated embodiment, the second locking member 170 is pivotally coupled to the housing 26 about the same pivot pin 138 as the first locking member 126. In other embodiments, separate pivot points may be used, so the first locking member and second locking member pivot about different axes. The second locking member 170 has a first end 174 and a second end 178. The second locking member 170 is pivotally coupled to the pivot pin 138 intermediate the first end 174 and second end 178. A second locking surface 182, similar to that on the first locking member 126, is provided at the first end 174 of the second locking member 170. The second locking surface 182 is configured to engage and compress the resilient jacket 38 of the cable 14, thereby preventing further movement in a second direction 186.

The second end 178 of the second locking member 170 is biased away from the cable by a second resilient member 190. Therefore, the second locking surface 182 is normally disengaged from the cable 14. In the illustrated embodiment, the second resilient member 190 is a coil extension spring.

As described in greater detail below, when the cable lock 10 is in a “locked” state, a third resilient member 194 is positioned to bias the second locking member 170 in the counter-clockwise direction (as illustrated) towards the cable 14. In the illustrated embodiment, the third resilient member 194 is a leaf spring 198. The biasing force of the leaf spring 198 is greater than the biasing force of the second resilient member 190. Therefore, when the leaf spring 198 is positioned as shown in FIG. 3A, the second locking member 170 is biased against the cable 14 to prevent cable movement in the second direction 186.

The leaf spring 198 is affixed to a motor-driven locking block 202. When in a locked position, shown in FIG. 3A, the locking block 202 is adjacent the second locking member 170 and simultaneously accomplishes two tasks. First, a trigger tab 206 of the locking block 202 is aligned with a solid portion 210 of the trigger 82, thereby preventing inward movement of the trigger 82 with respect to the housing 26. Thus, the first locking member 126 cannot be manually disengaged by the trigger 82. Second, the locking block 202 positions the leaf spring 198 to override the second resilient member 190, thereby forcing the second locking surface 182 into the locked position. Thus, with the locking block 202 in the first position 206, cable movement is prevented in both the first direction 154 and second direction 186.

When the locking block 202 is in a non-locked position, shown in FIGS. 3B and C, the leaf spring 198 no longer engages the second locking member 170. Furthermore, the trigger tab 206 is no longer aligned with the solid portion 210 of the trigger 82, thereby allowing inward trigger movement. In the illustrated embodiment, a cylindrical post member 212 is provided within the hollow portion 168 of trigger 82. The cylindrical post member 212 is configured to engage the second end 178 of the second locking member 170 when the trigger 82 is depressed inwardly into the housing 26. Thus, the cylindrical post member 212 provides a means of positively disengaging the second locking member 170 from the cable 14 if the biasing force of the second resilient member 190 is insufficient.

In the illustrated embodiment, the locking block 202 is threaded onto a lead-screw 214. The lead-screw 214 is rotated by an electric motor 218, powered by a battery 222. Rotation of the lead-screw 214 causes the locking block 202 to reposition. In other embodiments, the locking block 202 may be driven by other means. Other drive means for the locking block 202 may include a cable/pulley system, chain drive, gear, solenoid actuation, and others. In still other embodiments, the locking block may be manually actuated.

FIGS. 3A, B, and C illustrate the three operating modes of the cable lock 10: lock, cinch, and unlock, respectively.

As illustrated in FIG. 3A, with the leaf spring 198 in the locked position, the second locking member 170 is biased by the leaf spring 198 into contact with the cable 14. In combination with the first locking member 126, the second locking member 170 prevents movement of the cable 14 in either direction 154 or 186. In order to place the locking block 202 in a non-locked position, an appropriate code is typed into the keypad 74. This act causes the motor 218 to drive the locking block 202 and leaf spring 198 to the non-locked position.

As illustrated in FIG. 3B, with the leaf spring 198 in the non-locked position (i.e., the leaf spring 198 is not engaged with the second locking member), the cable lock 10 rests in the cinch mode due to the bias of the first resilient member 150 on the first locking member 126. When the cable 14 is put through the aperture 30, a user can tighten the cable loop 34, but not pull the cable back out of the housing. The harder one tries to pull the cable 14 out of the housing 26, the tighter the engagement of the first locking member 126 to the cable 14 becomes.

As illustrated in FIG. 3C, in order to detach the cable 14 or expand the cable loop 34 (i.e., “unlock”), the trigger 82 must be depressed in order to free the cable 14 from the first locking member 126. When the trigger 82 is depressed, the nub 162 disengages the first locking member 126 from the cable 14. Furthermore, the cylindrical post member 212 disengages the second locking member 170 from the cable 14 if the biasing force of the second resilient member 190 has not already done so. The cable 14 can then freely move through the lock in either direction 154 or 186.

When the trigger 82 is again released, as shown in FIG. 3B, the first resilient member 150 applies force to the first locking member 126 such that the cable can again only move in one direction (i.e., the cinch mode). In order to transition back to the locked mode, shown in FIG. 3A, the code is again entered into the keypad 74, causing the motor to drive the leaf spring 198 back to the locked position.

A lock as described herein has various advantages. For example, the harder someone tries to pull the cable 14 out of the housing 26, the more tightly the first locking member 126 engages the cable 14. Further, the cam profiles of the first locking surface 142 and second locking surface 182 lock the cable in two directions with practically no stress on any of the moving parts. The design of the locking members 126 and 170 require very little force to move into a locked position, thereby extending the useful life of the device. Additionally, locking is achieved in both directions 154 and 186.

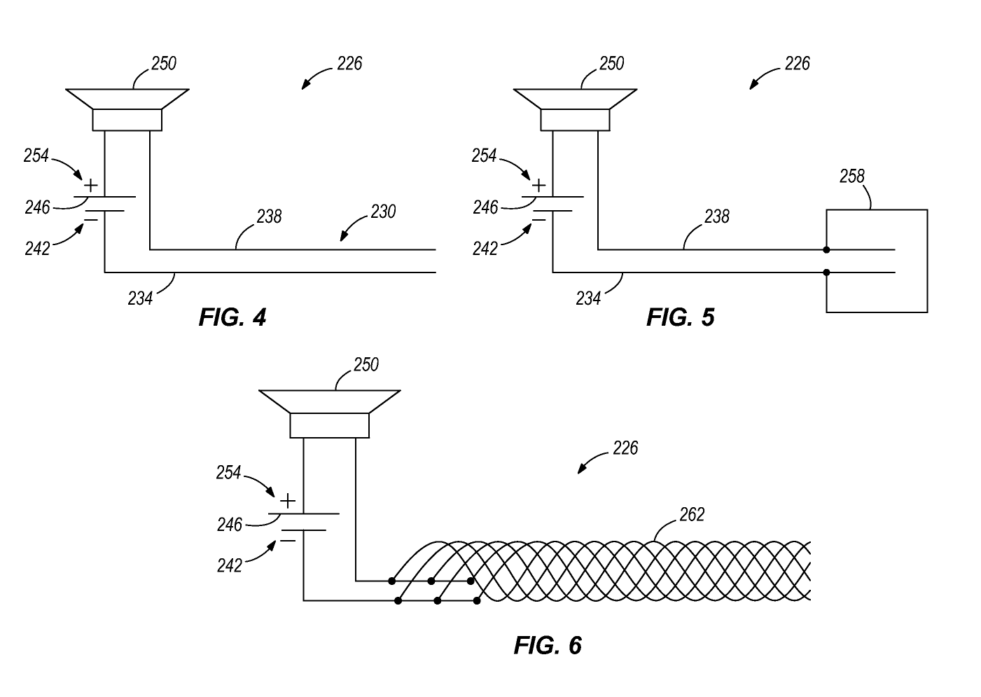

As shown in FIGS. 4, 5, and 6, the cable lock may additionally feature an alarm circuit 226. The alarm circuit 226 is operable to provide an audible signal upon a cable being cut. In other embodiments, the alarm circuit may provide a visual indication that the cable has been cut or tampered with, such as a flashing light.

FIG. 4 illustrates the alarm circuit 226, in a normal state of use, with a cable 230. The cable 230 is illustrated with only a first strand 234 and a second strand 238, though most embodiments will have more than two strands. The first strand 234 is connected at one end to the negative terminal 242 of a DC power source, such as a battery 246. The second strand 238 is connected at one end to a speaker 250. The speaker 250 is connected to the positive terminal 254 of the battery 230. The diagram of FIG. 4 illustrates the alarm-circuit 226 as an open-circuit. In other words, no current may flow from the battery 246 to the speaker 250.

FIG. 5 illustrates the result of an attempt to cut through the cable 230. A cutter blade 258 of a wire cutter or bolt cutter closes the alarm circuit 226 by pinching (or crimping) the first strand 234 and second strand 238 together. Electrical contact between the two strands causes current to flow from the battery 246 to the speaker 250, thereby producing an audible alarm. Even if the cutter blade 258 passes completely through the first and second strands 234 and 238, end portions of the strands remain in contact, and the speaker 250 continues to produce the audible alarm. In some embodiments, a latching relay or an electronic switch may be provided to maintain the alarm circuit 226 closed, even if the first and second strands 234 and 238 separate. In these embodiments, the speaker 250 will continue to emit an audible alarm until, for example, the proper code is entered into the lock. The audible signal emitted by the speaker 250 can be a siren, klaxon, recorded voice or other recording.

FIG. 6 illustrates a multi-stranded, braided cable 262 in the alarm circuit 226. The principles described with respect to FIGS. 4 and 5 apply to the configuration of FIG. 6 as well. The braided cable 262 is made from enamel-coated wire. Each strand of the braided cable 262 is alternately wired into the alarm circuit 226. These strands are insulated from one another by the enamel coating and, therefore, do not complete the circuit. When a cutting tool penetrates the enamel of the wires, it effectively acts as a switch by completing the circuit and activating the alarm buzzer. In other embodiments, the strands may be insulated by a rubber or plastic coating. As described above, a latching relay or electronic switch may additionally be provided to maintain the audible alarm.

In some embodiments, the alarm circuit further comprises a motion detector sub-circuit. The motion detector sub-circuit enables the audible alarm independent of the cable circuit. Thus, the motion detector allows for an alarm signal prior to tampering or cutting. In still other embodiments, the motion detector sub-circuit and/or alarm circuit may have a visual alarm feature such as a strobe or flashing red light.

In the illustrated embodiment, both the locking mechanism motor and the alarm circuit are powered by a single battery. The battery may be, for example, a Ryobi™ Tek4™ Lithium-Ion rechargeable battery. In some embodiments, the lock may also have a permanently installed or replaceable back-up battery. Such a back-up battery may be necessary if the rechargeable battery is discharged to the point that the locking mechanism motor can no longer drive the locking block out of position. As described above, the battery cannot be replaced unless the cable is withdrawn from battery cover aperture, and the cable cannot be withdrawn unless the locking block is in the unlocked position.

Thus, the invention provides, among other things, a cable lock with a variable length loop. Various features and advantages of the invention are set forth in the following claims.

What is claimed is:

1. A lock for engaging a cable, the lock comprising:
a housing having an aperture through which the cable may pass;
a first locking member coupled to the housing;
a second locking member coupled to the housing;
a first biasing member configured to bias the first locking member towards the cable to prevent cable movement in a first direction;
a second biasing member configured to bias the second locking member away from the cable;
a third biasing member configured to selectively bias the second locking member towards the cable to prevent cable movement in a second direction; and
a trigger movably coupled to the housing, the trigger configured to selectively deflect the first locking member away from the cable.

2. The lock of claim 1, wherein the first biasing member and second biasing member are coil springs.

3. The lock of claim 1, wherein the third biasing member is a leaf spring.

4. The lock of claim 1, wherein the third biasing member is coupled to a locking block, the locking block configured to selectively obstruct movement of the trigger.

5. The lock of claim 4, further comprising a drive mechanism coupled to the locking block for driving the locking block between a first position, in which the third biasing member engages the second locking member and the locking block obstructs movement of the trigger, and a second position, in which the third biasing member is disengaged from the second locking member and the locking block does not obstruct movement of the trigger.

6. The lock of claim 5, wherein the drive mechanism includes an electric motor and a lead screw.

7. The lock of claim 1, further comprising a pivot pin fixedly coupled to the housing, the first locking member and second locking member pivotally coupled to the housing at the pivot pin.

8. The lock of claim 1, wherein a first end of the cable is pivotally coupled to the housing and a second end of the cable passes through the aperture such that the cable forms a loop.

9. A cable lock, comprising:
a housing having a first aperture;
a cable having a first end and a second end, the first end coupled to the housing and the second end selectively passing through the first aperture;
a first cam member pivotally coupled to the housing, the first cam member biased to impinge upon the cable to prevent cable movement in a first direction and selectively disengaged from the cable to allow cable movement in the first direction; and
a second cam member pivotally coupled to the housing, the second cam member biased away from the cable in a first condition and biased towards the cable in a second condition, the second condition preventing cable movement in a second direction.

10. The cable lock of claim 9, further comprising a trigger mechanism movably coupled to the housing, the trigger operable to selectively disengage the first cam member from the cable to allow cable movement in the first direction.

11. The cable lock of claim 10, further comprising a locking block selectively positionable between a first position and a second position, wherein when the locking block is in the first position, the trigger is movable to selectively disengage the first cam member from the cable and when the locking block is in the second position, the trigger is blocked from movement and the second cam member is in the second condition.

12. The cable lock of claim 11, further comprising a battery-powered drive mechanism configured to drive the locking block from the first position to the second position and from the second position to the first position.

13. The cable lock of claim 12, further comprising a battery cover detachably coupled to the housing.

14. The cable lock of claim 13, wherein the battery cover comprises a second aperture which aligns with the first aperture when the battery cover is coupled to the housing.

15. The cable lock of claim 9, wherein the second cam member is biased by a leaf spring when in the second condition.

16. A cable lock alarm circuit, comprising;
an audible alarm member coupled to one of a positive terminal and a negative terminal of a power source;
a first plurality of wire strands coupled at a first end to the audible alarm member;
a second plurality of wire strands coupled to the other of the positive terminal and the negative terminal of the power source, the second plurality of wire strands being substantially coaxial with the first plurality of wire strands;
wherein the alarm circuit is normally an open circuit and further wherein cutting of the cable causes contact between the first plurality of wire strands and the second plurality of wire strands, thereby closing the alarm circuit.

17. The cable lock alarm circuit of claim 16, wherein the first plurality of wire strands and the second plurality of wire strands are interwoven to form a cable.

18. The cable lock alarm circuit of claim 17, wherein a wire strand of at least one of the first plurality of wire strands and the second plurality of wire strands has an electrically insulating outer layer.

19. The cable lock alarm circuit of claim 16, wherein the power source is a rechargeable battery.

20. The cable lock alarm circuit of claim 19, further comprising a back-up battery.
